(19) United States
(12) Patent Application Publication
(10) Pub. No.: US 2021/0399381 A1
(43) Pub. Date: Dec. 23, 2021

(54) CAST PIECE COOLING METHOD, GEL SHEET, MULTILAYER MICROPOROUS POLYETHYLENE SEPARATOR, AND PREPARATION METHOD

(71) Applicant: JIANGSU HORIZON NEW ENERGY TECH CO., LTD., Changzhou (CN)

(72) Inventors: Tao JIANG, Changzhou (CN); Xingxing WENG, Changzhou (CN); Zhengli WANG, Changzhou (CN); Aibin SUN, Changzhou (CN); Taotao LIU, Changzhou (CN)

(73) Assignee: JIANGSU HORIZON NEW ENERGY TECH CO., LTD., Changzhou (CN)

(21) Appl. No.: 17/272,260

(22) PCT Filed: Aug. 3, 2020
(86) PCT No.: PCT/CN2020/106586

§ 371 Date: Feb. 26, 2021

(30) Foreign Application Priority Data
Dec. 20, 2019 (CN) 201911323414.7

(51) Int. Cl. H01M 50/406; H01M 50/449; H01M 50/417; B32B 27/32; B32B 27/18; B32B 27/08; B29C 48/00; B29C 48/10; B29C 48/88

(52) U.S. Cl. CPC H01M 50/406; H01M 50/449; H01M 50/417; B32B 27/32; B32B 27/18; B32B 27/08; H01M 10/0525; B29C 48/10; B29C 48/9135; B29C 48/0018; B29C 48/0017; B29C 48/022; B29C 48/0011

(57) ABSTRACT

A cast piece cooling method, a gel sheet, a multilayer microporous polyethylene separator, and a preparation method are provided. The cast piece cooling method includes: changing an opening degree of a die head so that a molten material flowing out of the die head is an arc-shaped molten material; calendering a cast piece so that the arc-shaped molten material passes vertically through a gap between a first casting roller and a pinch roller to form a calendered cast piece; and gradually cooling, so that the calendered cast piece is guided and transported along surfaces of other casting rollers to the last casting roller, and cooling the calendered cast piece, to obtain a gel sheet.

### CROSS REFERENCE TO THE RELATED APPLICATIONS

This application is the national stage entry of International Application No. PCT/CN2020/106586, filed on Aug. 3, 2020, which is based upon and claims priority to Turkish Patent Application No. 201911323414.7, filed on Dec. 20, 2019, the entire contents of which are incorporated herein by reference.

### TECHNICAL FIELD

The present invention belongs to the field of lithium battery separator technologies, and in particular, relates to a cast piece cooling method, a gel sheet, a multilayer microporous polyethylene separator, and a preparation method thereof.

### BACKGROUND

As the new energy industry, lithium-ion batteries have received preference and support from the governments around the world over the past nearly 20 years since they are superior to traditional secondary batteries in aspects of volumetric energy density, gravimetric energy density, gravimetric power density, cycle life and charge/discharge efficiency. Lithium-ion batteries have a spiral winding structure inside, which requires a very fine and permeable separator material to separate positive and negative electrodes. The separator is one of the most important components in the lithium-ion battery. It is technologically complex and accounts for about 10%-20% of the cost of the battery. Profit margins of separators can reach 50%-60%. Currently, the market price of battery separator base material is 1.5-2 yuan/m², and the cost of the base material is generally 1-2 yuan/m². Hence, it is in urgent need of increasing the production speed to 60-100 m/min to reduce the production cost.

Current technical problems are that: the production efficiency cannot be improved mostly because of the tape casting technology used by almost all wet separator manufacturers. In the casting process of the tape casting technology, a molten material discharges out of a die head and enters vertically into a tangent position between a casting roller and a pinch roller to obtain a gel sheet by machining with a tape-casting process of free attachment. According to casting machining, the molten material at 190-250° C. may have the following disadvantages in the tape-casting process of free attachment: a) microporous structures on two sides vary greatly; b) the gel sheet has a necking ratio up to 10-15%, wherein the necking ratio=(molten material width at a die head outlet−gel sheet width of the last casting roller)/molten material width at the die head outlet*100%. In this case, the production speed of the cast piece is less than 6 m/min, and cannot be increased, but the machine-direction elongation ratio can only be increased by 8-15. However, too great of a machine-direction elongation ratio may lead to high tensile strength and low malleability of separators. These separators with poor flexibility are not conducive to battery processing.

### SUMMARY

An objective of the present invention is to provide a cast piece cooling method, a gel sheet, a multilayer microporous polyethylene separator, and a preparation method thereof.

In order to solve the above technical problems, the present invention provides a cast piece cooling method, including: changing an opening degree of a die head, wherein a molten material flowing out of the die head is an arc-shaped molten material; calendering a cast piece, wherein the arc-shaped molten material passes vertically through a gap between a first casting roller and a pinch roller to form a calendered cast piece; and gradually cooling, wherein the calendered cast piece is guided along surfaces of other casting rollers to the last casting roller, and cooling the calendered cast piece, to obtain a gel sheet.

Further, the step of changing an opening degree of a die head includes: keeping a ratio of an opening degree of a feeding middle portion of the die head to an opening degree of a feeding side portion as 1.1-2.0; and keeping a ratio of a molten material flow rate of the feeding middle portion of the die head to a molten material flow rate of the feeding side portion as 1.2-4.0.

Further, the middle of the first casting roller or the middle of the pinch roller is adapted to form a stacking position of the arc-shaped molten material, wherein a stacking width of the arc-shaped molten material is 10-200 mm, and a stacking height is 5-50 mm; and a thickness of the calendered cast piece formed by the arc-shaped molten material is 500-2000 μm.

Further, a necking ratio of the gel sheet=(molten material width at a die head outlet−gel sheet width of the last casting roller)/molten material width at the die head outlet*100%; and the necking ratio of the gel sheet is 0-10%.

Further, a transportation speed of the calendered cast piece is 6-12 m/min.

In a second aspect, the present invention further provides a gel sheet, obtained by cooling a molten material with the cast piece cooling method as described above.

The present invention has the following advantages: according to the cast piece cooling method and the gel sheet of the present invention, an opening degree of a die head is changed so that an arc-shaped molten material flows out of the die head. Then, the arc-shaped molten material passes through a gap between a first casting roller and a pinch roller to form a calendered cast piece. The calendered cast piece is guided along surfaces of other casting rollers to the last casting roller and gradually cooled to obtain a gel sheet. Under high speed production conditions, the consistency of microporous structures on both sides of the gel sheet can be maintained, the necking ratio of the gel sheet can be reduced and the production speed of the cast piece increased.

In a third aspect, the present invention provides a preparation method for a multilayer microporous polyethylene separator, including: mixing and extruding, wherein raw materials are melted and extruded to obtain a molten material; cooling the molten material by the above-described cast piece cooling method to obtain a gel sheet; asynchronously and bidirectionally elongating, wherein the gel sheet is elongated to obtain an elongated film; extracting, wherein the elongated film is washed through an extractant to remove paraffin oil, so as to obtain a separator; thermoforming; and rewinding and splitting to obtain a high-permeability multilayer microporous polyethylene separator.

Further, the raw materials include: mixed polyethylene resin with a mass fraction of 10-40% and paraffin oil with a mass fraction of 60-90%; wherein the mixed polyethylene resin includes: ultra-high molecular weight polyethylene resin and high-density polyethylene resin with a mass ratio of 5:5-95.

Further, a machine-direction elongation temperature of the asynchronously and bidirectionally elongating is 50-130° C.; and a machine-direction elongation ratio is 5-15.

In a fourth aspect, the present invention further provides a multilayer microporous polyethylene separator, including the following raw materials: mixed polyethylene resin with a mass fraction of 10-40% and paraffin oil with a mass fraction of 60-90%; wherein the mixed polyethylene resin includes: ultra-high molecular weight polyethylene resin and high-density polyethylene resin with a mass ratio of 5:5-95.

The present invention has the following advantages: according to the multilayer microporous polyethylene separator and a preparation method thereof in the present invention, an opening degree of a die head is changed so that an arc-shaped molten material flows out of the die head, then the arc-shaped molten material passes through a gap between a first casting roller and a pinch roller to form a calendered cast piece, and the calendered cast piece is guided along surfaces of other casting rollers to the last casting roller and is gradually cooled, so as to obtain a gel sheet. Under the condition of a high production speed, the consistency of microporous structures on both sides of the gel sheet can be maintained, the necking ratio of the gel sheet can be reduced, and the production speed of the cast piece can be increased. At a low elongation ratio, a multilayer polyethylene separator with high strength and high malleability can be prepared on the premise of keeping good flexibility of the separator and improving production efficiency of the separator.

Other features and advantages of the present invention will be described in the following specification, and become apparent in part from the following specification, or be learned from the practice of the present invention. The objectives and other advantages of the present invention are achieved and obtained in the structures specified in the specification, claims, and drawings.

In order to make the above objectives, features, and advantages of the present invention more obvious and understandable, preferred embodiments are given below and described in detail with reference to the drawings.

### BRIEF DESCRIPTION OF THE DRAWINGS

In order to more clearly illustrate specific embodiments of the present invention or the technical solutions in the prior art, the drawings used in the description of the specific embodiments or the prior art will be briefly introduced below. It is apparent that the drawings in the following description are only some embodiments of the present invention, and other drawings can be obtained by those of ordinary skill in the art from the drawings without creative efforts.

FIG. 1 is a flow chart of a cast piece cooling method according to the present invention.

FIG. 2 is a schematic structural diagram of a cast piece cooling apparatus according to the present invention.

FIG. 3 is a flow chart of a multilayer microporous polyethylene separator according to the present invention.

In FIG. 2, die head 1, feeding middle portion 11, feeding side portion 12, molten material 2, first casting roller 3, pinch roller 4, gap 5, other casting rollers 6, gel sheet 7.

### DETAILED DESCRIPTION OF THE EMBODIMENTS

In order to make the objectives, technical solutions, and advantages of embodiments of the present invention clearer, the technical solutions of the present invention are described clearly and completely below with reference to the drawings. It is apparent that the embodiments described herein are part of rather than all of the embodiments of the present invention. All other embodiments obtained by those of ordinary skill in the art based on the embodiments in the present invention without creative efforts fall within the protection scope of the present invention.

### Embodiment 1

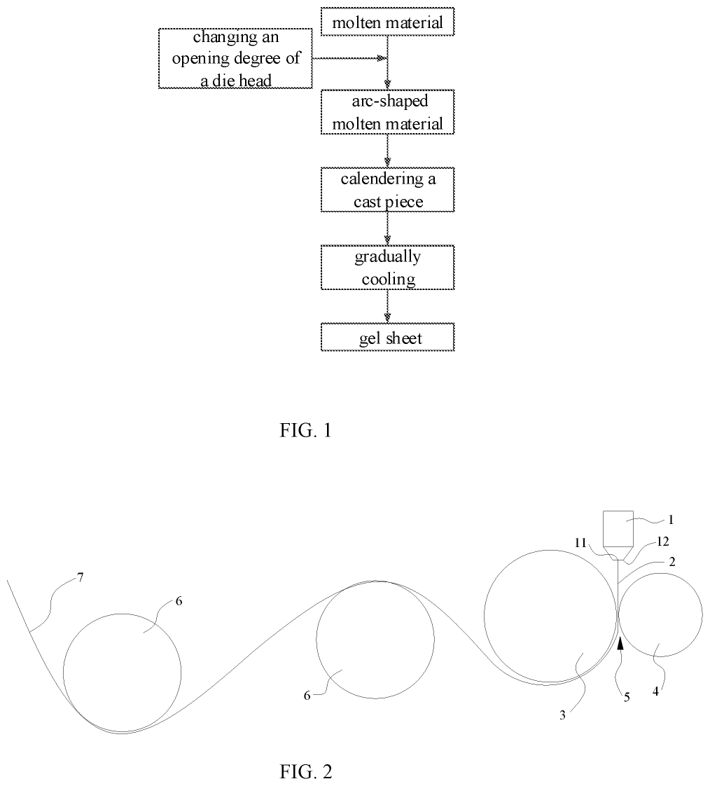

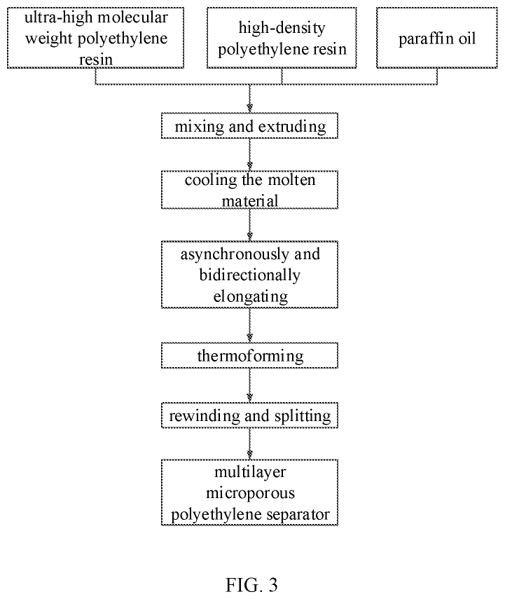

FIG. 1 is a flow chart of a cast piece cooling method according to the present invention.

FIG. 2 is a schematic structural diagram of a cast piece cooling apparatus according to the present invention.

As shown in FIGS. 1-2, the cast piece cooling method in Embodiment 1 includes: changing an opening degree of a die head 1, wherein the opening degree is a degree to which an article opens, and a molten material 2 flowing out of the die head 1 is an arc-shaped molten material; calendering a cast piece, wherein the arc-shaped molten material 2 passes vertically through a gap 5 between a first casting roller 3 and a pinch roller 4 to form a calendered cast piece; and gradually cooling, wherein the calendered cast piece is guided along surfaces of other casting rollers 6 to the last casting roller, and cooling the calendered cast piece, to obtain a gel sheet 7, wherein the arc-shaped molten material at 190-250° C. is gradually cooled to obtain a gel sheet at 20-50° C.

Optionally, a stacking width of the gap 5 is 10-200 mm, preferably 50-100 mm, and a stacking height thereof is 5-50 mm, preferably 10-30 mm. The middle of the first casting roller 3 or the middle of the pinch roller 4 is adapted to form a stacking position of the arc-shaped molten material, wherein a stacking width of the arc-shaped molten material is 10-200 mm, and a stacking height is 5-50 mm. A thickness of the calendered cast piece formed by the arc-shaped molten material is 500-2000 μm, which is suitable for a wet-process multilayer microporous polyethylene separator with a thickness of 5-25 μm.

The molten material is deposited to form a stack with a certain height and width between the first casting roller 3 and the pinch roller 4 to ensure a stable casting process. A stacking midline is exactly the same as a midline of the casting roller.

Optionally, a necking ratio of the gel sheet=(molten material width at a die head outlet−gel sheet width of the last casting roller)/molten material width at the die head outlet*100%. The necking ratio of the gel sheet is 0-10%, preferably 4%-8%. The reduction of the necking ratio of the gel sheet not only can increase the production speed of the cast piece, but also can increase the machine-direction elongation ratio on the premise of ensuring flexibility and malleability, and further improve the production efficiency.

Optionally, a transportation speed of the calendered cast piece is 6-12 m/min, preferably 7-10 m/min.

An optional implementation for changing an opening degree of a die head is as follows.

Referring to FIG. 2, the method of changing an opening degree of a die head includes: keeping a ratio of an opening degree of a feeding middle portion 11 of the die head 1 to an opening degree of a feeding side portion 12 as 1.1-2.0, wherein the die head opening degree ratio=the bolt opening degree in the middle position/the bolt opening degree in the side position, and is preferably 1.3-1.7; and keeping a ratio of a molten material flow rate of the feeding middle portion 11 of the die head to a molten material flow rate of the feeding side portion 12 as 1.2-4.0, preferably 1.5-2.5.

The method of changing the opening degree of the die head in this implementation can make feeding flow rates of the die head inconsistent, so that the molten material flowing out appears arc-shaped to form an arc-shaped molten material, and the gel sheet with a stable size and thickness can be obtained in the casting process, so as to ensure the stability of production.

### Embodiment 2

On the basis of Embodiment 1, Embodiment 2 further provides a gel sheet, obtained by cooling a molten material by the cast piece cooling method as described above.

A specific implementation process of the gel sheet can be obtained according to the related description in Embodiment 1, and is not repeated herein.

### Embodiment 3

On the basis of Embodiment 1 and Embodiment 2, Embodiment 3 further provides a preparation method for a multilayer microporous polyethylene separator, including: mixing and extruding, wherein raw materials are melted and extruded to obtain a molten material; cooling the molten material by the cast piece cooling method as described above to obtain a gel sheet; asynchronously and bidirectionally elongating, wherein the gel sheet is elongated to obtain an elongated film; extracting, wherein the elongated film is washed through an extractant to remove paraffin oil, and to obtain a separator; thermoforming; and rewinding and splitting to obtain a high-permeability multilayer microporous polyethylene separator.

Optionally, the asynchronously and bidirectionally elongating includes: sequentially carrying out machine-direction (MD) elongation and transverse-direction (TD) elongation on the gel sheet. The gel sheet is successively elongated 5-15 times at the temperature of 50-130° C. to obtain an elongated film of 5-60 μm.

Optionally, the extracting includes: making the elongated film pass through an extracting tank, washing by using an extractant to remove paraffin oil in micro holes of the separator, and then removing the extractant by drying, to obtain the separator. The extractant is generally a chemical reagent compatible with paraffin oil, such as dichloromethane.

Optionally, a temperature of the thermoforming is 100-150° C.

Optionally, the rewinding and splitting includes: first rewinding the thermoformed separator by a rewinding machine at a speed of 60-100 m/min, and then splitting it by a splitting machine at a speed of 100-200 m/min to obtain multilayer micro-porous polyethylene separators of different widths.

A specific implementation process of the cast piece cooling method can be obtained according to the related description in Embodiment 1, and is not repeated herein.

An optional implementation for mixing and extruding is as follows

Raw materials are melted and extruded through a twin-screw co-rotating extruder (the temperature of the extruder is controlled to be 190-250° C.) to obtain a molten material at 190-250° C. The raw materials include: mixed polyethylene resin with a mass fraction of 10-40% and paraffin oil with a mass fraction of 60-90%. The mixed polyethylene resin includes: ultra-high molecular weight polyethylene resin and high-density polyethylene resin with a mass ratio of 5:5-95. A mean molecular weight of the ultra-high molecular weight polyethylene resin is 1*10⁶-4*10⁶, and a mean molecular weight of the high-density polyethylene resin is 5*10⁵-8*10⁵. The paraffin oil is liquid, solid, or a mixture of both, with a molecular weight of 300-1500.

Optionally, the raw materials include: mixed polyethylene resin with a mass fraction of 20% and paraffin oil with a mass fraction of 80%; wherein the mixed polyethylene resin includes: ultra-high molecular weight polyethylene resin and high-density polyethylene resin with a mass ratio of 5:30.

Optionally, the raw materials include: mixed polyethylene resin with a mass fraction of 30% and paraffin oil with a mass fraction of 70%; wherein the mixed polyethylene resin includes: ultra-high molecular weight polyethylene resin and high-density polyethylene resin with a mass ratio of 5:50.

Optionally, the raw materials include: mixed polyethylene resin with a mass fraction of 35% and paraffin oil with a mass fraction of 65%; wherein the mixed polyethylene resin includes: ultra-high molecular weight polyethylene resin and high-density polyethylene resin with a mass ratio of 5:80.

Through mixing and extruding in this implementation, the ultra-high molecular weight polyethylene resin, the high-density polyethylene resin, and the paraffin oil are melted and extruded to obtain a molten material at 190-250° C. and the molten material flows out from a die head, which can improve the strength and elongation of the separator in terms of the raw materials.

### Embodiment 5

(1) Mixing and Extruding

First, ultra-high molecular weight polyethylene resin and high-density polyethylene resin with a mass ratio of 5:30 are mixed to form mixed polyethylene resin. The mixed polyethylene resin with a mass fraction of 25% and paraffin oil with a mass fraction of 75% are proportionally mixed, and then are melted and extruded through a twin-screw co-rotating extruder (the temperature of the extruder is controlled to be 200° C.) to obtain a molten material at 200° C.

(2) Cast Piece Cooling

An opening degree of a die head is changed. A ratio of an opening degree of a feeding middle portion of the die head to an opening degree of a feeding side portion is kept as 1.7, and a ratio of a molten material flow rate of the feeding middle portion of the die head to a molten material flow rate of the feeding side portion is kept as 2.5, so that a molten material flowing out of the die head is an arc-shaped molten material. Then, the arc-shaped molten material passes vertically through a gap between a first casting roller and a pinch roller. A stacking width of the gap is kept as 100 mm, and a stacking height is 30 mm. The arc-shaped molten material forms a calendered cast piece. The calendered cast piece is guided and transported along surfaces of other casting rollers to the last casting roller, and a transportation speed of the calendered cast piece is controlled to be 10 m/min so that the calendered cast piece is fully cooled to obtain a gel sheet with a necking ratio of 4%. Specifically, the arc-shaped molten material at 200° C. is gradually cooled to obtain a gel sheet at 30° C.

(3) Asynchronously and Bidirectionally Elongating

Machine-direction elongation (MD) and transverse-direction elongation (TD) are sequentially carried out on the gel sheet. The gel sheet is successively elongated 5 times at the temperature of 100° C. to obtain an elongated film of 15.7 μm.

(4) Extracting

The elongated film passes through an extracting tank. The paraffin oil in micro holes of the separator is washed and removed by dichloromethane. The dichloromethane is removed by drying, thereby obtaining the separator.

(5) Thermoforming

The separator is thermoformed at 120° C.

(6) Rewinding and Splitting

The thermoformed separator is first rewound by a rewinding machine at a speed of 60 m/min, and then split by a splitting machine at 150 m/min to obtain multilayer micro-porous polyethylene separators of different widths.

### Embodiment 6

(1) Mixing and Extruding

First, ultra-high molecular weight polyethylene resin and high-density polyethylene resin with a mass ratio of 5:45 are mixed to form mixed polyethylene resin. The mixed polyethylene resin with a mass fraction of 25% and paraffin oil with a mass fraction of 75% are proportionally mixed and then melted and extruded through a twin-screw co-rotating extruder (the temperature of the extruder is controlled to be 200° C.) to obtain a molten material at 200° C.

(2) Cast Piece Cooling

An opening degree of a die head is changed. A ratio of an opening degree of a feeding middle portion of the die head to an opening degree of a feeding side portion is kept as 1.3, and a ratio of a molten material flow rate of the feeding middle portion of the die head to a molten material flow rate of the feeding side portion is kept as 1.5, so that a molten material flowing out of the die head is an arc-shaped molten material. Then, the arc-shaped molten material passes vertically through a gap between a first casting roller and a pinch roller. A stacking width of the gap is kept as 50 mm, and a stacking height is 10 mm. The arc-shaped molten material forms a calendered cast piece. The calendered cast piece is guided and transported along surfaces of other casting rollers to the last casting roller, and a transportation speed of the calendered cast piece is controlled to be 7 m/min so that the calendered cast piece is fully cooled to obtain a gel sheet with a necking ratio of 8%. Specifically, the arc-shaped molten material at 200° C. is gradually cooled to obtain a gel sheet at 30° C.

(3) Asynchronously and Bidirectionally Elongating

Machine-direction elongation (MD) and transverse-direction elongation (TD) are sequentially carried out on the gel sheet. The gel sheet is successively elongated 10 times at the temperature of 100° C. to obtain an elongated film of 11.87 μm.

(4) Extracting

The elongated film passes through an extracting tank. The paraffin oil in micro holes of the separator is washed and removed by dichloromethane, and then the dichloromethane is removed by drying, to obtain the separator.

(5) Thermoforming

The separator is thermoformed at 120° C.

(6) Rewinding and Splitting

The thermoformed separator is first rewound by a rewinding machine at a speed of 100 m/min, and then split by a splitting machine at 150 m/min to obtain multilayer micro-porous polyethylene separators of different widths.

### Embodiment 7

(1) Mixing and Extruding

First, ultra-high molecular weight polyethylene resin and high-density polyethylene resin with a mass ratio of 5:75 are mixed to form mixed polyethylene resin, and then the mixed polyethylene resin with a mass fraction of 40% and paraffin oil with a mass fraction of 60% are proportionally mixed, and are melted and extruded through a twin-screw co-rotating extruder (the temperature of the extruder is controlled to be 210° C.) to obtain a molten material at 210° C.

(2) Cast Piece Cooling

An opening degree of a die head is changed. A ratio of an opening degree of a feeding middle portion of the die head to an opening degree of a feeding side portion is kept as 1.1, and a ratio of a molten material flow rate of the feeding middle portion of the die head to a molten material flow rate of the feeding side portion is kept as 1.2, so that a molten material flowing out of the die head is an arc-shaped molten material. Then the arc-shaped molten material passes vertically through a gap between a first casting roller and a pinch roller. A stacking width of the gap is kept as 10 mm, and a stacking height is 5 mm. The arc-shaped molten material forms a calendered cast piece. The calendered cast piece is guided and transported along surfaces of other casting rollers to the last casting roller, and a transportation speed of the calendered cast piece is controlled to be 12 m/min so that the calendered cast piece is fully cooled to obtain a gel sheet with a necking ratio of 10%. Specifically, the arc-shaped molten material at 210° C. is gradually cooled to obtain a gel sheet at 20° C.

(3) Asynchronously and Bidirectionally Elongating

Machine-direction elongation (MD) and transverse-direction elongation (TD) are sequentially carried out on the gel sheet. The gel sheet is successively elongated 15 times at the temperature of 50° C. to obtain an elongated film of 9.01 μm.

(4) Extracting

The elongated film passes through an extracting tank. The paraffin oil in micro holes of the separator is washed and removed by dichloromethane. The dichloromethane is removed by drying, thereby obtaining the separator.

(5) Thermoforming

The separator is thermoformed at 150° C.

(6) Rewinding and Splitting

The thermoformed separator is first rewound by a rewinding machine at a speed of 100 m/min, and then split by a splitting machine at 200 m/min to obtain multilayer micro-porous polyethylene separators of different widths.

### Embodiment 8

(1) Mixing and Extruding

First, ultra-high molecular weight polyethylene resin and high-density polyethylene resin with a mass ratio of 5:5 are mixed to form mixed polyethylene resin. The mixed polyethylene resin with a mass fraction of 10% and paraffin oil with a mass fraction of 90% are proportionally mixed, and then are melted and extruded through a twin-screw co-rotating extruder (the temperature of the extruder is controlled to be 220° C.) to obtain a molten material at 220° C.

(2) Cast Piece Cooling

An opening degree of a die head is changed. A ratio of an opening degree of a feeding middle portion of the die head to an opening degree of a feeding side portion is kept as 1.1, and a ratio of a molten material flow rate of the feeding middle portion of the die head to a molten material flow rate of the feeding side portion is kept as 1.2, so that a molten material flowing out of the die head is an arc-shaped molten material. Then the arc-shaped molten material passes vertically through a gap between a first casting roller and a pinch roller. A stacking width of the gap is kept as 10 mm, and a stacking height is 5 mm. The arc-shaped molten material forms a calendered cast piece. The calendered cast piece is guided and transported along surfaces of other casting rollers to the last casting roller, and a transportation speed of the calendered cast piece is controlled to be 6 m/min so that the calendered cast piece is fully cooled, to obtain a gel sheet with a necking ratio of 6%. Specifically, the arc-shaped molten material at 220° C. is gradually cooled to obtain a gel sheet at 20° C.

(3) Asynchronously and Bidirectionally Elongating

Machine-direction elongation (MD) and transverse-direction elongation (TD) are sequentially carried out on the gel sheet. The gel sheet is successively elongated 5 times at the temperature of 50° C. to obtain an elongated film of 5 μm.

(4) Extracting

The elongated film passes through an extracting tank. The paraffin oil in micro holes of the separator is washed and removed by dichloromethane. The dichloromethane is removed by drying, to obtain the separator.

(5) Thermoforming

The separator is thermoformed at 150° C.

(6) Rewinding and Splitting

The thermoformed separator is first rewound by a rewinding machine at a speed of 60 m/min, and then split by a splitting machine at 100 m/min to obtain multilayer micro-porous polyethylene separators of different widths.

### Embodiment 9

(1) Mixing and Extruding

First, ultra-high molecular weight polyethylene resin and high-density polyethylene resin with a mass ratio of 5:95 are mixed to form mixed polyethylene resin. Then, the mixed polyethylene resin with a mass fraction of 40% and paraffin oil with a mass fraction of 60% are proportionally mixed, and are melted and extruded through a twin-screw co-rotating extruder (the temperature of the extruder is controlled to be 250° C.) to obtain a molten material at 250° C.

(2) Cast Piece Cooling

An opening degree of a die head is changed. A ratio of an opening degree of a feeding middle portion of the die head to an opening degree of a feeding side portion is kept as 2.0, and a ratio of a molten material flow rate of the feeding middle portion of the die head to a molten material flow rate of the feeding side portion is kept as 4.0, so that a molten material flowing out of the die head is an arc-shaped molten material. Then the arc-shaped molten material passes vertically through a gap between a first casting roller and a pinch roller. A stacking width of the gap is kept as 200 mm, and a stacking height is 100 mm. The arc-shaped molten material forms a calendered cast piece. The calendered cast piece is guided and transported along surfaces of other casting rollers to the last casting roller, and a transportation speed of the calendered cast piece is controlled to be 12 m/min so that the calendered cast piece is fully cooled to obtain a gel sheet with a necking ratio of 10%. Specifically, the arc-shaped molten material at 250° C. is gradually cooled to obtain a gel sheet at 50° C.

(3) Asynchronously and Bidirectionally Elongating

Machine-direction elongation (MD) and transverse-direction elongation (TD) are sequentially carried out on the gel sheet. The gel sheet is successively elongated 15 times at the temperature of 130° C. to obtain an elongated film of 60 μm.

(4) Extracting

The elongated film passes through an extracting tank. The paraffin oil in micro holes of the separator is washed and removed by dichloromethane. The dichloromethane is removed by drying, to obtain the separator.

(5) Thermoforming

The separator is thermoformed at 100° C.

(6) Rewinding and Splitting

The thermoformed separator is first rewound by a rewinding machine at a speed of 100 m/min, and then split by a splitting machine at 200 m/min to obtain multilayer micro-porous polyethylene separators of different widths.

### Embodiment 10

(1) Mixing and Extruding

First, ultra-high molecular weight polyethylene resin and high-density polyethylene resin with a mass ratio of 5:40 are mixed to form mixed polyethylene resin. The mixed polyethylene resin with a mass fraction of 20% and paraffin oil with a mass fraction of 80% are proportionally mixed, and then are melted and extruded through a twin-screw co-rotating extruder (the temperature of the extruder is controlled to be 200° C.) to obtain a molten material at 200° C.

(2) Cast Piece Cooling

An opening degree of a die head is changed. A ratio of an opening degree of a feeding middle portion of the die head to an opening degree of a feeding side portion is kept as 1.5, and a ratio of a molten material flow rate of the feeding middle portion of the die head to a molten material flow rate of the feeding side portion is kept as 2.5, so that a molten material flowing out of the die head is an arc-shaped molten material. Then the arc-shaped molten material passes vertically through a gap between a first casting roller and a pinch roller. A stacking width of the gap is kept as 100 mm, and a stacking height is 70 mm. The arc-shaped molten material forms a calendered cast piece. The calendered cast piece is guided and transported along surfaces of other casting rollers to the last casting roller, and a transportation speed of the calendered cast piece is controlled to be 9 m/min so that the calendered cast piece is fully cooled to obtain a gel sheet with a necking ratio of 5%. Specifically, the arc-shaped molten material at 200° C. is gradually cooled to obtain a gel sheet at 30° C.

(3) Asynchronously and Bidirectionally Elongating

Machine-direction elongation (MD) and transverse-direction elongation (TD) are sequentially carried out on the gel sheet. The gel sheet is successively elongated 10 times at the temperature of 80° C. to obtain an elongated film of 30 μm.

(4) Extracting

The elongated film passes through an extracting tank, paraffin oil in micro holes of the separator is washed by dichloromethane and removed, and then dichloromethane is removed by drying, to obtain the separator.

(5) Thermoforming

The separator is thermoformed at 125° C.

(6) Rewinding and Splitting

The thermoformed separator is first rewound by a rewinding machine at a speed of 80 m/min, and then split by a splitting machine at 150 m/min to obtain multilayer micro-porous polyethylene separators of different width specifications.

### COMPARATIVE EXAMPLE

(1) Mixing and Extruding

Common polyethylene resin with a mass fraction of 20% and paraffin oil with a mass fraction of 80% are proportionally mixed, and then are melted and extruded through a twin-screw co-rotating extruder (the temperature of the extruder is controlled to be 200° C.) to obtain a molten material at 200° C.

(2) Cast Piece Cooling

The molten material is discharged out of a die head and enters vertically into a tangent position between a casting roller and a pinch roller to obtain a gel sheet with a necking ratio of 15% by a tape-casting method of free attachment. Specifically, the molten material at 200° C. is cooled to obtain a gel sheet at 50° C.

(3) Asynchronously and Bidirectionally Elongating

Machine-direction elongation (MD) and transverse-direction elongation (TD) are sequentially carried out on the gel sheet. The gel sheet is successively elongated 15 times at the temperature of 130° C. to obtain an elongated film of 8.8 μm.

(4) Extracting

The elongated film passes through an extracting tank. The paraffin oil in micro holes of the separator is washed and removed by dichloromethane. The dichloromethane is removed by drying, to obtain the separator.

(5) Thermoforming

The separator is thermoformed at 100° C.

(6) Rewinding and Splitting

The thermoformed separator is first rewound by a rewinding machine at a speed of 60 m/min, and then split by a splitting machine at 100 m/min to obtain polyethylene separators of different widths.

### Embodiment 11

The polyethylene separators prepared in Embodiments 5-7 and the comparative embodiment are tested respectively in Embodiment 11, and test results thereof are as shown in Table 1.

TABLE 1
Comparison of parameters of polyethylene separators

| | Experimental group | | | |
|---|---|---|---|---|
| | Embodi- | Embodi- | Embodi- | Comparative |
| | ment 5 | ment 6 | ment 7 | example |
| Thickness (μm) | 15.7 | 11.87 | 9.01 | 8.8 |
| MD tensile strength | 3050 | 2985 | 3000 | 2400 |
| (kg/cm²) | | | | |
| TD tensile strength | 2950 | 2900 | 3050 | 2330 |
| (kg/cm²) | | | | |
| MD elongation (%) | 180% | 172% | 165% | 110% |
| TD elongation (%) | 155% | 160% | 152% | 128% |
| Width (mm) | 3000 | 3000 | 3000 | 3000 |
| Production line speed | 60 | 100 | 100 | 100 |
| (m/min) | | | | |
| Production cost | 0.4-0.8 | 0.4-0.7 | 0.3-0.6 | 1.0-2.0 |
| (yuan/m²) | | | | |

In combination with Embodiments 5-7 and the comparative example, it can be seen that the MD tensile strength, the MD elongation, the TD tensile strength, and the TD elongation of the multilayer microporous polyethylene separator according to the present invention are all higher than those of the conventional technology because of the cast piece cooling method in the present application. In the cast piece cooling method, an opening degree of a die head is changed to make feeding flow rates of the die head inconsistent, so that the molten material flowing out appears arc-shaped. A necking ratio of a gel sheet is reduced through gradual cooling of the molten material, which can ensure uniform microporous structures on two sides of the separator. The production speed and a machine-direction elongation ratio of the cast piece increase on the premise of guaranteeing flexibility and malleability, thereby improving the production efficiency. Ultra-high molecular weight polyethylene resin and high-density polyethylene resin are mixed according to the stoichiometric proportion of raw materials, thereby controlling the performance of the separator, and obtaining a separator with high strength and high elongation. In this way, the yield of products is improved and the production cost decreases.

Inspired by the above ideal embodiments of the present invention, the person skilled in the art can make various changes and modifications without departing from the technical ideas of the present invention through the above description. The technical scope of the present invention is not limited to the contents of the specification but has to be determined according to the scope of the claims.

What is claimed is:

1. A cast piece cooling method, comprising:
changing an opening degree of a die head, wherein a molten material flowing out of the die head is an arc-shaped molten material;
calendering a cast piece, wherein the arc-shaped molten material passes vertically through a gap between a first casting roller and a pinch roller to form a calendered cast piece; and
gradually cooling, wherein the calendered cast piece is guided and transported along surfaces of middle casting rollers to a last casting roller, and the calendered cast piece is cooled to obtain a gel sheet.

2. The cast piece cooling method according to claim 1, wherein
the step of changing the opening degree of the die head comprises:
keeping a ratio of an opening degree of a feeding middle portion of the die head to an opening degree of a feeding side portion of the die head as 1.1-2.0; and
keeping a ratio of a molten material flow rate of the feeding middle portion of the die head to a molten material flow rate of the feeding side portion of the die head as 1.2-4.0.

3. The cast piece cooling method according to claim 1, wherein
a middle of the first casting roller or a middle of the pinch roller is configured to form a stacking position of the arc-shaped molten material, wherein
a stacking width of the arc-shaped molten material is 10-200 mm, and a stacking height of the arc-shaped molten material is 5-50 mm; and
a thickness of the calendered cast piece formed by the arc-shaped molten material is 500-2000 μm.

4. The cast piece cooling method according to claim 1, wherein
R=(Wₘ−W_{g})/Wₘ*100%
wherein R is a necking ratio of the gel sheet, Wₘ is molten material width at a die head outlet, and W_{g} is gel sheet width of the last casting roller; and
the necking ratio of the gel sheet is 0-10%.

5. The cast piece cooling method according to claim 1, wherein
a transportation speed of the calendered cast piece is 6-12 m/min.

6. A gel sheet, wherein
the gel sheet is obtained by cooling a molten material with the cast piece cooling method according to claim 1.

7. A preparation method for a multilayer microporous polyethylene separator, comprising:
mixing and extruding, wherein raw materials are melted and extruded to obtain a molten material;
cooling the molten material by the cast piece cooling method according to claim 1 to obtain the gel sheet;
asynchronously and bidirectionally elongating, wherein the gel sheet is elongated to obtain an elongated film;
extracting, wherein the elongated film is washed through an extractant to remove paraffin oil, and to obtain a separator;
thermoforming; and
rewinding and splitting to obtain the multilayer microporous polyethylene separator, wherein the multilayer microporous polyethylene separator is high-permeability.

8. The preparation method according to claim 7, wherein
the raw materials comprise: mixed polyethylene resin with a mass fraction of 10-40% and the paraffin oil with a mass fraction of 60-90%; wherein
the mixed polyethylene resin comprises: ultra-high molecular weight polyethylene resin and high-density polyethylene resin, wherein a mass ratio of the ultra-high molecular weight polyethylene resin to the high-density polyethylene resin is 5:5-95.

9. The preparation method according to claim 8, wherein
a machine-direction elongation temperature of the asynchronously and bidirectionally elongating is 50-130° C.; and a machine-direction elongation ratio is 5-15.

10. A multilayer microporous polyethylene separator, comprising:
mixed polyethylene resin with a mass fraction of 10-40% and paraffin oil with a mass fraction of 60-90%; wherein
the mixed polyethylene resin comprises: ultra-high molecular weight polyethylene resin and high-density polyethylene resin, wherein a mass ratio of the ultra-high molecular weight polyethylene resin to the high-density polyethylene resin is 5:5-95.
